(19) United States
(12) Patent Application Publication
(10) Pub. No.: US 2002/0096120 A1
(43) Pub. Date: Jul. 25, 2002

(54) Feed and water dispensing apparatus for pets

(76) Inventor: Ryan J. Busha, Marietta, GA (US)

Correspondence Address: William B. Noll, 402 Anemone Street, Panama City Beach, FL, 32413, US

(21) Appl. No.: 09/769,620

(22) Filed: Jan. 24, 2001

(51) Int. Cl. A01K 1/10

(52) U.S. Cl. 119/51.5

(57) ABSTRACT

An automatic feed and water dispensing apparatus for pets, where such pets may be left unattended for extended periods of time. The apparatus includes a housing having a pair of fixed hoppers and an intermediate rotating drum for transferring selected quantities of feed between the fixed hoppers. Additionally, the apparatus sidably and removably mounts a water dispensing receptacle.

### FIELD OF THE INVENTION

This invention is directed to the field of automatic, electrically powered food and water feeding apparatus for pets, such as cats and dogs, where the apparatus may include a timing mechanism for dispensing pet food at desired intervals to ensure freshness of the dispensed food.

### BACKGROUND OF THE INVENTION

The present invention relates to an automatic feed and water dispensing apparatus for providing pets with fresh food and clean water. Households with pets, particularly in the United States, is growing each year. With such growth, it must be recognized that often the households have two working adults such that the pets must be left unattended for extended periods of time. This extended stay can cause a number of problems for the pets, such as having to wait for fresh food and water. This can be a special problem for pets, particularly dogs, which are left outdoors in a fenced yard, even with appropriate shelter from the weather. Typically the owner would leave a bowl of water and a supply of food for the pet's convenience, which in time can become stale and undesirable to the pet. The patented prior art teaches a number of devices that attempt to provide pets, whether inside or out, with a supply of food and water. However, none offer the freshness and convenience of the present invention. Such prior art is reflected in the following U.S. Patents:

a.) U.S. Pat. No. 4,069,793, to Gower, teaches a pet feeding apparatus having a plurality of food-containing tubes, each of which is opened at spaced time intervals by a trap door held closed by the retractable plunger of an electrical relay connected in electrical series to an electrical timer. Upon receiving a signal from the timer, the plunger of the relay is retracted to allow the trap door to open by gravity to dispense pet food in one of the food tubes. Simultaneously, a solenoid valve is opened for a fixed time interval to drain water from a water tank to mix with the pet food and to supply drinking water for the pet.

b.) U.S. Pat. No. 4,665,862, to Pitchford, Jr., relates to a timed, automatic pet food and water dispenser which incorporates a leveraged loading storage bin for receiving a supply of particulate pet feed and having means for mixing water with said particulate feed, therewith to produce a gravy and a softening of said particulate feed. A feed dispensing auger measures a predetermined amount of said particulate feed and furnishes said feed to a feed dish at predetermined time intervals controlled by a timer system. A water container comprising level control means provides water for drinking purposes independently of said timer system.

c.) U.S. Pat. No. 5,363,805, to Wing, is directed to an automatic pet feeder which consists of a cabinet to sit upon a flat surface. A hopper is built into the cabinet for storing solid food therein so a bowl may be externally positioned adjacent the cabinet on the flat surface. Further, a device is disclosed for dispensing some of the solid food from the hopper directly into the bowl, so that a pet can feed from the bowl. An apparatus is provided for programming the dispensing device to control the frequency and the amount of the solid food delivered into the bowl.

d.) U.S. Pat. No. 5,372,093, to Pooshs, teaches an animal feeding apparatus which includes at least two chambers that each have a hollow passage therethrough to which access is provided by two openings positioned at opposite ends of each chamber. First and second receptacles for containing liquid have apertures in a lower portion thereof for releasing liquid therefrom. A support vertically supports the chambers one above the other so that one of the chambers is in an upper position and the other chamber is in a lower position and positions the chambers so that the hollow passage of the upper chamber is substantially aligned with the hollow passage of the lower chamber and so that the chambers are vertically higher than a feeding area. The support supports the second receptacle in a position that is vertically above the first receptacle. Upper and lower releasable blocking assemblies are associated with the upper and lower chambers, respectively, for supporting food within the hollow passages. First and second valves open the apertures in the first and second receptacles, respectively. A control system releases the upper and lower releasable blocking assemblies so that food contained in the hollow passage of the lower chamber falls out of the lower chamber to the feeding area and so that food contained in the hollow passage of the upper chamber falls out of the upper chamber and through the hollow passage of the lower chamber to the feeding area.

e.) U.S. Pat. No. 5,588,394, to Balistreri, relates to an automatic animal feeder which has a structural base and a vertical support onto which a feed reservoir is attached. A rotary feed measure having a cavity inside is disposed directly beneath the reservoir and when rotated, meters a fixed volume of dry feed to a feed bin positioned below. Rotation of the measure is actuated by a ballast tank that is pivotally connected to the measure on outwardly extending arms. A water solenoid valve opens on cyclic command of an electronic controller filling the tank, which by virtue of its increased weight, is pulled down by gravity dumping the feed into the bin. When the tank has pivoted downwardly and is full, a siphon tube dumps all of the water into a water dish separate from the apparatus, and a spring returns the empty tank to its reset position, thus automatically feeding and watering an animal.

f.) U.S. Pat. No. 5,794,560, to Terenzi, is directed to an automatic dog and cat feeder having an elongated vertical housing enclosing a hopper in the upper portion thereof. Its lower end is the funnel outlet hole. A spring-loaded cone valve below the outlet prevents the dry pellet particular feed from being released. The cone valve movement is solenoid-operated with timers. One timer selects the time of day for feeding, the other timer the amount of feed released. This is regulated by a predetermined setting the cone valve remains open for large or small pets' needs. The feed delivery system is housed in a container which in turn when in operation directs dry pellet particular feed to the exterior of the feeder into a feed dish.

While the above prior art illustrates and describes a number of approaches for automatically providing feed and/or water for unattended pets, the respective approaches are generally complex and subject to breaking down. The present invention, on the other hand, offers an effective, yet not complex, system for satisfying the needs of pets. The manner by which the present invention meets these needs will be found in the following description, particularly when read in conjunction with the accompanying drawings.

### SUMMARY OF THE INVENTION

This invention relates to an automatic food and water dispensing apparatus for household pets, such as dogs and cats. The apparatus comprises a generally closed housing having a feed hopper, an exit hopper, and a rotating drum, intermediate said hoppers for transferring\selective quantities of food from the entry hopper to the exit hopper. The system further includes external means for regulating the quantity of transmitted food, an intermittent, electrically powered motor and timer mechanism to rotate the drum to effect the timely transfer of food. The drum includes an axle mounting a gear in meshing relationship to a complementary gear on the motor. Further, the exit hopper features a slanted floor to gravity feed food deposited therein into a waiting bowl, where said bowl may be removably secured to the housing. Finally, in removable and sliding engagement with the housing is a water dispensing receptacle.

Accordingly, an object of this invention is to provide an effective system to dispense selected quantities of food to a pet receptacle, particularly for those pets that may be left unattended for extended periods of time.

Another object hereof lies in the use of a pair of enclosed, fixed hoppers and an intermediate rotating drum for transferring food from one fixed hopper to another.

A further object of the invention is the provision of a food dispensing housing having a water dispensing receptacle sidably and removably secured thereto.

These and other objects will become more apparent to those skilled in the art from the following description, particularly when read in conjunction with the accompanying drawings.

### BRIEF DESCRIPTION OF DRAWINGS

FIG. 1 is a perspective view of the feed and water dispensing apparatus for pets according to the present invention, with parts cut away showing internal details of the food dispensing mechanism, and a removable dish spaced from the water dispensing source, which in turn is removably secured to the food dispensing mechanism hereof.

FIG. 2 is a front view of the apparatus of FIG. 1, where the removable dish is position beneath the water dispensing source.

FIG. 3 is a top view of the water dispensing source forming a part of this invention.

### DETAILED DESCRIPTION OF PREFERRED EMBODIMENT

The present invention is directed to an automatic food and water dispensing apparatus that can be used to meet the nourishment needs of an unattended pet, such as cats and dogs. The invention will now be described with regard to the accompanying Figures where like reference numerals represent like components or features throughout the several views.

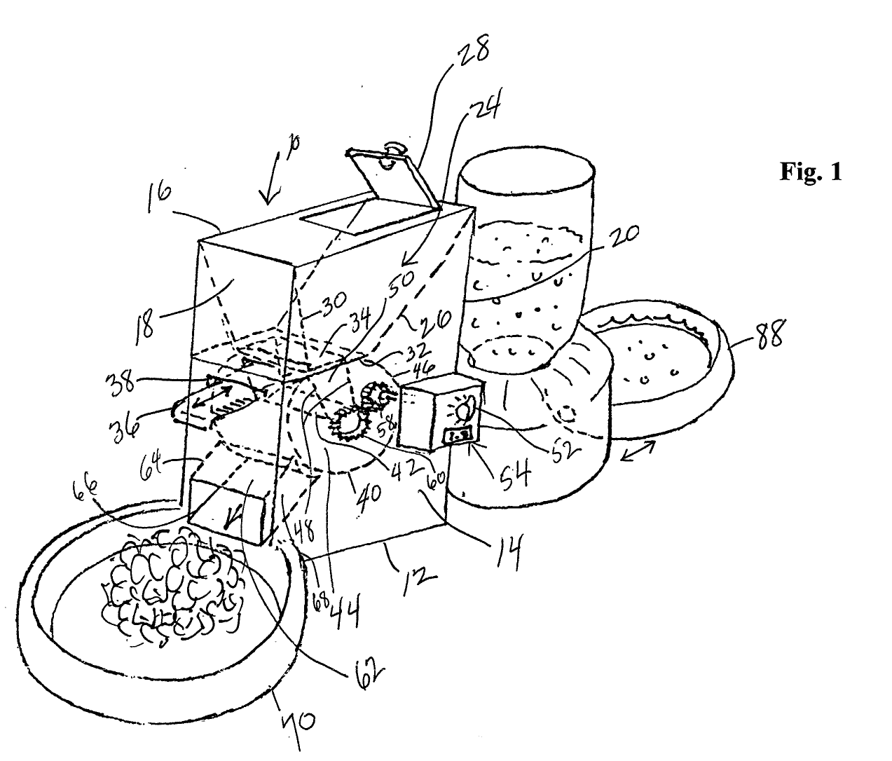

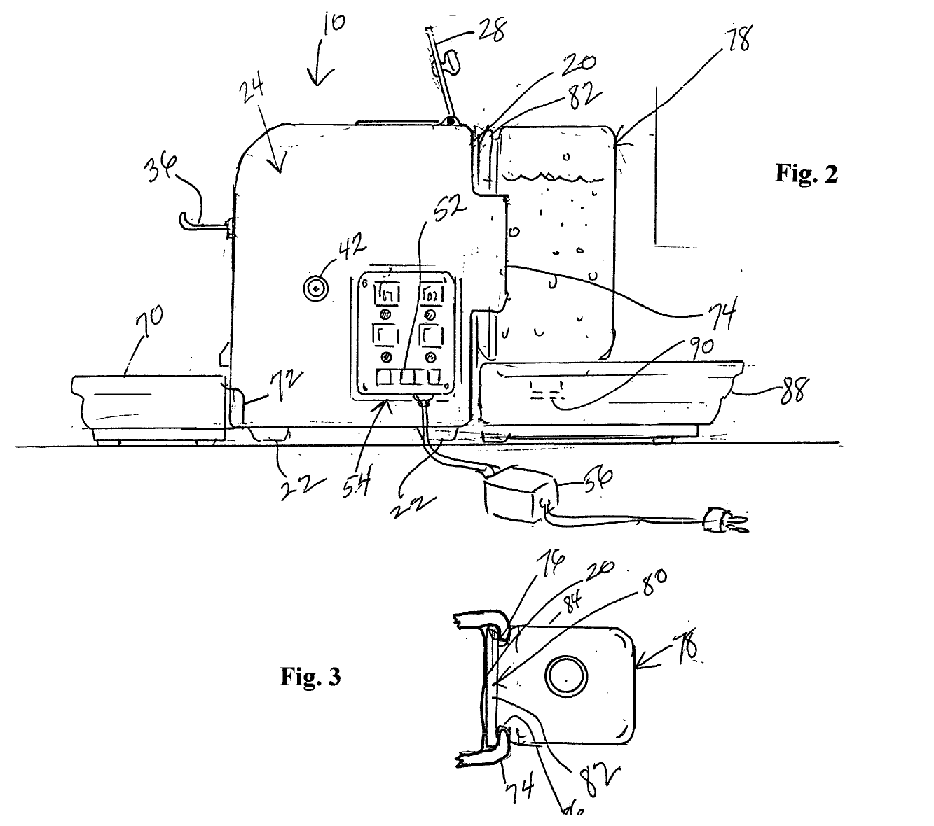

Turning now to the several Figures, FIGS. 1 and 2 illustrate the full apparatus forming the invention hereof. The invention comprises a generally rectangular or box-like, food dispensing housing 10 having a base 12 on which the housing seats, front and rear faces 14, 16, respectively, a first end wall 18 and a second end wall 20. To support the base 12, plural feet 22 may be added as seen in FIG. 2.

Internally, as best seen in FIG. 1, the housing 10 includes a food entry hopper 24 comprised of a first angled face 26 underlying a hinged door 28, through which food is fed to the hopper, a second angled face 30, and a bottom wall 32. The respective angled walls and bottom wall, in conjunction with the inside of front and rear wall 14, 16, define the contained hopper 24. The bottom wall 32 includes a slotted opening 34, where the size of the opening may be controlled by the manually movable arm 36 extending through the face slot 38 in the first end wall 18 for externally regulating same. Disposed below the slotted opening 34 is a rotating drum 40 featuring a rotating axle 42 and a pair of circular side walls 44. Extending radially from the periphery 46 of the circular side walls 44 to the axle 42 are a pair of spaced apart radial walls 48. The radial wall, along with the side walls 44 define a rotating cavity 50 for receiving a regulated quantity of food, through opening 34, from hopper 24.

To rotate the drum 40 a timer 52, preferably mounted along front face 14, see FIGS. 1 and 2, a timer mechanism and motor 54 is provided. The timer mechanism and motor 54, powered by battery (not shown) or by electrical house power through a low voltage converter 56, as known in the art, may include a manual ON/OFF switch, means to input time intervals for operation, and a slow speed motor, all of which are known in the art. In any case, the motor intermittently rotates a first gear 58 which in turn meshes with and rotates a second gear 60 connected to the axle 42. As the drum rotates, under the action of the timed motor, the contents of the rotating cavity 50 is delivered to an exit hopper 62. The exit hopper is defined by the upper and lower walls 64, 66, respectively, and side walls 68. The exit hopper is open at both ends, and is angled downwardly to allow the deposited food to pass through into a removable dish 70. Since dogs sometimes have a tendency to move the dish in their excitement to get to the food, the dish 70 optionally may be fastened to the corners 72 of the front and rear faces 14, 16. A suitable fastening means may be a hook and pile type fastener, known commercially as VELCRO, a trademark.

As best seen in FIGS. 2 and 3 the second end face 20 is characterized by a pair of outwardly and inwardly directed arms 74 to define opposing slots 76, see FIG. 3. Cooperating with the opposing slots 74 is a water receptacle 78, preferably square in shape, having a first side wall 80 featuring a T-shaped configured face, i.e. a planar face portion 82 separated from the receptacle portion 84 by the reduced neck portion 86. By this arrangement, the water receptacle 78 can be removably and slidably engaged with the end face 20 as illustrated in FIG. 3. Finally, a removable water dish 88 may be provided to underlie the water receptacle 78 to supply an essentially endless supply of fresh water to the dish 88. So long as the opening 90 of the water receptacle is immersed below the water level of the dish 88, water remains fresh and isolated from the dish. However, as the pet drinks from the dish, and the water level goes below the opening 90, and new water is added to the dish.

It is recognized that variations, modifications and changes may be made to the design, construction and intended purpose of the feed and water dispensing apparatus hereof without departing from the spirit and scope of the invention. Accordingly, no limitation is intended to be imposed thereon except as set forth in the appended claims.

1. An automatic food and water dispensing apparatus for pets, said apparatus comprising:
a.) a generally closed housing having a feed hopper, an exit hopper, and an intermediate rotating drum for the timely and selective transfer of food from said feed hopper to said exit hopper, and means for intermittently rotating said drum; and
b.) a water dispensing receptacle removably attached to the exterior of said housing.

2. The automatic food and water dispensing apparatus according to claim 1, including means for externally accessing and providing food to said feed hopper.

3. The automatic food and water dispensing apparatus according to claim 2, including external means to regulate the quantity of food transferred to said rotating drum.

4. The automatic food and water dispensing apparatus according to claim 3, including an opening between said feed hopper and said drum, and said external means comprises a manually operable arm to limit the size of size of said opening.

5. The automatic food and water dispensing apparatus according to claim 3, wherein said rotating drum is generally circular in configuration and rotatable about an axle, and includes a radially oriented, pie shaped cavity for receiving a preferred quantity of food from said feed hopper.

6. The automatic food and water dispensing apparatus according to claim 1, wherein said exit hopper includes an angled floor to gravity feed food dispensed therein to a pet feeding receptacle.

7. The automatic food and water dispensing apparatus according to claim 6, wherein said pet feeding receptacle is a bowl removably secured to said housing.

8. The automatic food and water dispensing apparatus according to claim 5, including an electrically powered timer mechanism for automatically operating said rotating drum.

9. The automatic food and water dispensing apparatus according to claim 8, wherein said timer mechanism includes a motor operating a gear in meshing relationship to a gear on said axle.

10. The automatic food and water dispensing apparatus according to claim 1, wherein said housing includes a first face having a pair of inwardly directed arms to define a slot, and said water dispensing receptacle is configured to be slidably received within said slot.

11. The automatic food and water dispensing apparatus according to claim 10, wherein said water dispensing receptacle is generally square in cross section and features a face having a planar member connected by a narrow neck portion to said water dispensing receptacle, where said planar member is sized for sliding engagement within said slot.
